(19) United States
(12) Patent Application Publication
(10) Pub. No.: US 2026/0103548 A1
(43) Pub. Date: Apr. 16, 2026

(54) PROCESS FOR PRODUCING POLYPROPYLENE-ETHYLENE RANDOM COPOLYMER RESIN WITH SUSTAINABLE REACTOR OPERABILITY

(71) Applicant: W.R. Grace & Co.-CONN., Columbia, MD (US)

(72) Inventors: Ping Cai, Lake Jackson, TX (US); Matthew J. Fedec, Lake Jackson, TX (US)

(21) Appl. No.: 18/911,988

(22) Filed: Oct. 10, 2024

(51) Int. Cl. C08F 2/34; C08F 4/02; C08F 210/06

(52) U.S. Cl. CPC C08F 2/34; C08F 4/022; C08F 210/06

(57) ABSTRACT

A gas-phase polymerization process is disclosed for producing polypropylene random copolymers with excellent reactor operability and/or particle morphology. The polypropylene random copolymer is produced while maintaining the partial pressure of the propylene monomer within controlled limits based upon the amount of comonomer present and the operating temperature.

### BACKGROUND

Polypropylene, a type of polyolefin polymer, generally has a linear structure based on a propylene monomer. One type of polypropylene is a polypropylene random copolymer, which is produced using propylene monomer and comonomer(s) of at least one other α-olefin, such as ethylene and/or 1-butene, which are interspersed randomly within the polypropylene chain. Polypropylene random copolymers exhibit properties that are particularly useful for pipe, packaging, textile, molding, and other applications.

One method for producing polypropylene is typically referred to as gas phase polymerization. During gas phase polymerization, one or more monomers contact a catalyst, forming a bed of polymer particles that are maintained in a fluidized state by a fluidizing medium or are otherwise stirred or agitated. A typical gas phase polymerization reactor includes a vessel containing a bed, a distribution plate (also called distributor plate), and a product discharge system. A catalyst can be fed into the polymerization reactor and contacted with an olefin monomer that forms part of the fluidizing medium.

When producing polypropylene using a gas-phase process, it is important to maintain the operating temperature of the reactor by efficient heat transfer from the polymer particles to the fluidizing gas. Failure to properly remove heat can cause softening and/or melting of the polymer particles which can cause agglomeration of the particles, sheeting on the reactor walls, and at worst, chunking and blockage of the distribution plate and product discharging system, requiring shut down of the reactor for cleaning, which typically takes the reactor off-line for days.

Compared to other polypropylene types, random copolymers are relatively more challenging to produce. For example, the presence of the comonomer, especially ethylene, can increase the heat of the reaction and reduce the melting temperature of the polymer, meaning more heat needs to be removed compared to homopolymer production, and the polymer particles tend to be relatively “stickier.” As such, efficient heat transfer from the polymer particles to the gas is particularly important when producing polypropylene random copolymers. Even following conventional operation guidelines, the random copolymer operation could still have problems like polymer agglomeration, unstable reactor temperature, abnormal fluidized bulk density (FBD)/bed level, hot spots in the reactor, etc.

In the past, in order to control heat transfer and/or produce a polypropylene random copolymer resin while minimizing problems like polymer agglomeration, propylene partial pressures during the process were reduced for reducing the reaction heat generated at each active site of the catalyst. Although somewhat successful, problems still persist in maintaining good and sustainable reactor operability (exampled by unstable fluidization, reactor-wall temperature excursion and polymer agglomeration), and/or producing resin particles having a desired more-spherical morphology as opposed to producing particles having a popcorn-like morphology and/or producing particles that tend to agglomerate. In fact, the challenge in reactor operability and particle morphology control can be strongly linked. A bad reactor operability is often associated with bad particle morphology. Thus, further improvements in processes for producing polypropylene random copolymers are still needed.

### SUMMARY

In general, the present disclosure is directed to an improved process for producing polypropylene-ethylene random copolymers with sustainable reactor operability and/or desired particle morphology. Through the process of the present disclosure, for instance, problems experienced in the past, such as particle agglomeration, sheeting on the reactor walls, and blockages in the product discharge system can be eliminated or minimized. In fact, particles can be produced according to the process of the present disclosure that have a more uniform and regular shape instead of producing irregular particles, such as particles having a popcorn-like shape. As will be described in greater detail below, the process of the present disclosure improves fluidization quality in the reactor creating a stable and sustainable operation, and optimum throughput.

In one aspect, the process comprises feeding a fluidizing medium into a reactor vessel containing a bed of catalytically active polyolefin particles. In one embodiment, the fluidizing medium comprises propylene gas, ethylene, hydrogen, and at least one inert gas. In accordance with the present disclosure, the propylene gas is maintained in the reactor vessel at a partial pressure according to the following relationship (or within the following range):

$${0.9}^{*} ( 4.31 - 0.301 Et - 0.015 T ) < PPpropylene < {1.1}^{*} ( 4.31 - 0.301 Et - 0.015 T )$$

wherein:
Et is the ethylene content in the copolymer (in wt %);
T is the bed temperature (in ° C.); and
PPpropylene is the partial pressure of propylene (in MPa).

The ethylene content in the copolymer can be greater than about 2% by weight and less than about 10% by weight, such as less than about 6% by weight.

The inert gas fed to the reactor vessel can be a hydrocarbon gas, such as propane and/or a nitrogen gas.

In one aspect, the process further includes the step of recycling the fluidizing medium exiting the reactor vessel back to the reactor vessel. Further amounts of propane and/or propylene can be combined with the recycled fluidizing medium for feeding to the reactor vessel. In one aspect, the partial pressure of propane in the reactor vessel is maintained according to the following relationship:

$$PPpropane = PPtotal\_C3 - PPpropylene$$

wherein:
PPpropane is the partial pressure of propane;
PPtotal_C3 is the total partial pressure of C3 hydrocarbons (e.g., propylene and propane); and
PPpropylene is the partial pressure of propylene.

In one aspect, at least a portion of the fluidizing gases recycled back to the reactor vessel condenses during the process. For instance, the fluidizing medium can contain propane which partially condenses during the recycle loop, similar to propylene. In one aspect, it is preferred to have some level of propane in the system, so the desired level of condensing can be achieved at a desired reactor temperature, without the need to adjust the amount of propylene to an undesired range. For example, propylene partial pressure can be maintained at a certain value or within a certain range while adjusting the level of propane in the system in order to achieve the target of condensing level. The PPpropane according to the above formula can be adjusted during the process so that the level of condensing of the cycle gas is from about 5% by weight to about 18% by weight. The condensing level of the cycle gas, for instance, can be adjusted by adding propane to the fluidizing medium. In one embodiment, the fluidizing medium contains propane in an amount from about 6 mol % to about 23 mol %, such as in an amount from about 8 mol % to about 20 mol %. In one aspect, the PPtotal_C3 can be maintained during the process within a range of from about 1.5 MPa to about 3.0 MPa, such as from about 1.7 MPa to about 2.8 MPa.

The process further includes the step of feeding a catalyst into the reactor vessel. The catalyst, for instance, can be a Ziegler-Natta catalyst or can be a metallocene catalyst.

Through the process of the present disclosure, a polypropylene random copolymer resin can be produced in the form of particles. The polypropylene random copolymer, for instance, can comprise a polypropylene-ethylene random copolymer. The polypropylene random copolymer can be comprised primarily of an easy flow powder with a certain particle size distribution. The particle shape, in general, could be somewhat near spherical or not too irregular.

Through the process of the present disclosure, a polypropylene random copolymer resin can be produced in the gas-phase reactor sustainably with good operability. The reactor can operate with stable fluidization (featured by the stable fluidized bulk density), free of polymer agglomeration (e.g., in the form of chunks and “sheets”), free of abnormal hot spots on the reactor wall or in the middle of the reactor, and with a stable reactor temperature profile. The reactor can maintain such operability continuously.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying FIGURE, in which:

FIG. 1 is a diagrammatical view of one embodiment of a gas phase polymerization process in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a gas-phase process for producing a polypropylene random copolymer in a fluidized bed reactor. In accordance with the present disclosure, it was discovered that a good reactor operability can be achieved or optimized by varying the partial pressure of propylene in the reactor vessel based on the product being formed and the reactor temperature, together optionally with the proper level of condensing. For instance, in one aspect, the partial pressure of propylene can be operated in the reactor vessel in relationship to the amount of comonomer present. More particularly, it was unexpectedly discovered that there is a link between the comonomer content of the polypropylene random copolymer, the reactor temperature, and the partial pressure of propylene during the process that, when controlled, can produce a product at optimum reactor operability. For instance, in accordance with the present disclosure, excellent reactor operability can be maintained by maintaining the propylene partial pressure in the reactor vessel during the process within the following range or limits:

$${0.9}^{*} ( 4.31 - 0.301 Et - 0.015 T ) < PPpropylene < {1.1}^{*} ( 4.31 - 0.301 Et - 0.015 T )$$

wherein:
Et is the ethylene content in the copolymer (in wt %);
T is the bed temperature (in ° C.); and
PPpropylene is the partial pressure of propylene (in MPa).

As used herein, maintaining a parameter (such as partial pressure or an amount of a constituent) within a range or within limits means that the parameter falls within the range after reactor startup and during normal or peak polymer production, excluding the phase of reactor shutdown.

In the past, problems were experienced in producing polypropylene random copolymers, particularly propylene-ethylene random copolymers, with desired reactor operability and particle morphology characteristics. In the past, for instance, it was common for irregular resin particles and/or polymer agglomerates to be produced during the process, such as popcorn-like particles and other agglomerations. Such particles can negatively affect the fluidization quality in the reactor. The irregular particles and agglomerates can cause various disadvantages when operating the process. For instance, the production of irregular resin particles can cause clogging of the product discharge system. Problems were also experienced in the past in controlling reactor heat removal resulting in the production of hot spots within the reactor which can not only cause particle agglomeration, but can also cause the reactor to shut down.

In accordance with the present disclosure, it was discovered that controlling the partial pressure of propylene in the reactor in relation to the comonomer content and the bed temperature, together optionally with proper level of condensing of the cycle gas, can minimize or even eliminate the problems described above. Through the process of the present disclosure, a quantitative system has been discovered for the optimization of propylene partial pressure that optimizes reactor operation. In addition, particle morphology can optionally be dramatically improved which prevents against flow constrictions or blockages during the process or other negative effects on reactor operability.

For example, through the process of the present disclosure, polypropylene random copolymer particles can be produced that have a desired shape, size, and uniformity. For example, in one aspect, the process of the present disclosure can produce easy-flow spherical-like particles. In one aspect, none of the particles can be greater than the openings in a U.S. Number 5 Mesh Size (5 openings per linear inch) and with low fines level (<5% wt). The fines level is defined by the weight percentage of the resin which can pass through a U.S. Number 120 Mesh Size. Such an easy-flow good product morphology can promote uniform gas flow and intensive mixing in the reactor, reduce the risk of reactor fouling, and ensure efficient heat and mass transfer. It minimizes agglomeration, reduces channeling or dead zones in the reactor, and allows for better fluidization in the gas-phase polymerization process.

The occurrence of agglomerates can be minimized or eliminated with the method invented by this work. For example, in one aspect, polypropylene random copolymer particles can be produced in which none of the particles have a particle size greater than an US #5 mesh sieve size.

The average particle size of the random copolymer polymer particles made in gas-phase reactors can be from about 50 microns to about 2000 microns. For instance, the average particle size can be greater than about 100 microns, such as greater than about 200 microns, such as greater than about 300 microns, such as greater than about 400 microns, and less than about 1500 microns, such as less than about 1200 microns, such as less than about 1000 microns. Average particle size can be determined according to the sieving analysis defined by ASTM D1912.

Polymer particles made according to the present disclosure can also display a normal particle size distribution without significant portions of very small particles (i.e., fines) or very large particles (e.g., above U.S. Number 5 Mesh and popcorn, flakes, chips, sheets, etc.). Producing particles having a normal size distribution, for instance, improves fluidization and minimizes particle segregation. A normal particle size distribution helps prevent clumping or large particle formations which can lead to uneven polymerization, reactor fouling, and operational instability. In addition, the process of the present disclosure can minimize the formation of fines or very small particles. The production of excessive fines can result in poor fluidization, increased reactor fouling, and dust issues in downstream processes/equipment like purge bin, convey line, bag filter, and extrusion.

As described above, the process of the present disclosure is directed to controlling the partial pressure of propylene in the fluidizing medium in relation to temperature and comonomer content. The fluidizing medium fed to the reactor vessel contacts a bed of catalytically active polyolefin particles. The fluidizing medium can contain propylene gas, a comonomer gas, hydrogen, and/or at least one inert gas. The comonomer gas, for instance, can comprise ethylene.

In one aspect, one or more inert gases are contained in the fluidizing medium and controlled in a manner that further promotes optimum fluidization and catalyst productivity. For instance, in one embodiment, the inert gas contained in the fluidizing medium can comprise propane alone or in combination with nitrogen gas. Including propane in the fluidizing medium, for instance, increases the total pressure and gas density of the fluidizing medium within the reactor vessel while still controlling the partial pressure of propylene. Increasing total pressure and gas density, for instance, can increase the momentum flux of the fluidizing medium and promote good fluidization, without causing over-heating of the polymerization reactor and the generation of hot spots.

In this regard, in one embodiment, in addition to controlling the partial pressure of propylene, the process can also include the control of propane content in the fluidizing medium (e.g., the cycle gas) within the reactor vessel. In one aspect, for instance, the reactor vessel is operated at a relatively high propane content in the cycle gas. This can be done by maintaining a relatively high level of propane that accumulates in the reactor via a vent recovery system manipulation and/or adding additional propane to the fluidizing medium (also called “propane dosing”).

Practically, the level of propane in the fluidization medium can be detected by the cycle-gas analyzer, and shown as mole % of the cycle gas. Then propane partial pressure can be obtained by multiplying the mole % of propane by the total pressure of the reactor. Then, the partial pressure of propane can be measured or even controlled according to the present disclosure according to the following relationship:

$$PPpropane = PPtotal\_C3 - PPpropylene$$

wherein:
PPpropane is the partial pressure of propane;
PPtotal_C3 is the total partial pressure of C3 hydrocarbons (e.g., propylene and propane); and
PPpropylene is the partial pressure of propylene.

The partial pressure of propylene in the above relationship is maintained within the range provided previously and depends on comonomer content and temperature.

The above relationship is intended to increase/maintain the total pressure of C3 hydrocarbons for the purpose of reaching desired condensing level and/or density of the fluidizing medium, without causing any adverse consequences that may result from too high propylene partial pressure, inadequate or excessive propane buildup within the reactor.

During the process, the fluidizing medium enters the reactor vessel, fluidizes the polymer particles, and exits the reactor vessel. The fluidizing medium is then recycled back to the reactor vessel and combined with further amounts of propylene, comonomer, hydrogen, and/or inert gas. When propane is present in the fluidizing medium, a portion of the propane will condense during the recycle phase. The above relationship with respect to the partial pressure of propane maintains optimum propane levels that can increase the density and/or total pressure of the fluidizing medium without excessive condensation occurring. Excessive condensation, for instance, can result in various adverse consequences. For instance, excessive condensation can increase the pressure of the product discharge system and reduce the temperature of the resin and product degassing column. This may lead to difficulty in achieving a good resin degassing, may produce a higher load on the vent recovery system which can cause a lower operational efficiency, and can increase resin particle stickiness. An excessive level of condensing gas might also trigger insufficient mixing near the bottom of the reactor vessel by lowering the effective gas velocity before the condensates are evaporated.

In this regard, during the process of the present disclosure, the partial pressure of propane is maintained such that an amount of condensing gas, after the heat exchanger, is from about 5% by weight to about 20% by weight. For instance, the amount of condensing gas within the recycle loop can be greater than about 6% by weight, such as greater than about 7% by weight, and less than about 19% by weight, such as less than about 18% by weight.

In general, the amount of propane contained in the fluidizing medium is from about 6% by mole to about 23% by mole. For instance, the amount of propane in the fluidizing medium can be greater than about 7% by mole, such as greater than about 8% by mole, and in an amount less than about 21% by mole, such as in an amount less than about 19% by mole.

During the process, the total partial pressure of the C3 hydrocarbons (PPtotal_C3) is generally greater than about 1.5 MPa, such as greater than about 1.6 MPa, such as greater than about 1.7 MPa, such as greater than about 1.8 MPa, and less than about 3.0 MPa, such as less than about 2.9 MPa, such as less than about 2.8 MPa.

In addition to propane, the fluidizing medium can also contain another inert gas, such as nitrogen gas. Including an additional inert gas, for instance, can increase the momentum flux and can be used to control the amount of gases that condense during the process. Inert gas can be condensable like propane, or non-condensable like nitrogen. Nitrogen can also serve to purge nozzles and pressure taps within the gas-phase polymerization reactor. During reactor startup, nitrogen can also be heavily used as the fluidizing medium before the monomer and comonomer are introduced into the reactor.

In one aspect, nitrogen constitutes about 4 mol % of the fluidizing medium or greater, such as about 6 mol % of the fluidizing medium or greater, such as about 7 mol % of the fluidizing medium or greater, such as about 9 mol % of the fluidizing medium or greater, such as about 11 mol % of the fluidizing medium or greater, such as about 13 mol % of the fluidizing medium or greater, such as about 15 mol % of the fluidizing medium or greater, such as about 19 mol % of the fluidizing medium or greater, such as about 25 mol % of the fluidizing medium or greater, and less than about 60 mol % of the fluidizing medium.

In one embodiment, the fluidizing medium contains both propane and nitrogen. Preferably, the sum of the mol % propane and the mol % nitrogen within the fluidizing medium is about 10% or greater, such as about 16% or greater, such as about 25% or greater, such as about 32% or greater. Typically, the sum of the mol % propane and the mol % nitrogen is less than about 70%.

The gas density of the fluidizing medium, ρ_{g}, is preferably about 55 kg/m³ or greater, such as about 57 kg/m³ or greater, such as about 58 kg/m³ or greater, such as about 59 kg/m³ or greater, such as about 60 kg/m³ or greater. The gas density of the fluidizing medium is typically less than about 80 kg/m³, such as less than about 70 kg/m³.

In general, the polymerization described herein is conducted in a fluidized-bed gas-phase reactor, although the process can also be carried out in a stirred or agitated reactor. The polymerization is conducted by reacting propylene and at least one olefin comonomer. The comonomer can comprise ethylene, preferably in the presence of hydrogen, to produce a propylene-based polymer. The catalyst system can be a metallocene catalyst system or a Ziegler Natta catalyst system, or even a mixture of Ziegler-Natta and metallocene catalysts. Preferably, the catalyst system is a Ziegler Natta catalyst system.

The propylene polymer can be a propylene copolymer (with single comonomer or more). As used herein, the term propylene copolymer is used broadly to refer to embodiments having a single comonomer or multiple comonomers, therefore including terpolymers. The temperature of the polymerization is preferably from about 50 to about 90° C., such as from about 55 to about 75° C., or alternately from about 58 to about 68° C. When hydrogen is present, the ratio of hydrogen to propylene used in the polymerization is preferably about 0.003 to about 0.25, such as from about 0.005 to about 0.18.

The melt flow rate (MFR) of the propylene polymer produced, measured according to ASTM D1238, is typically from about 0.15 to about 400 g/10 min, where measurement of the MFR includes the addition of an antioxidant to provide stable, repeatable measurements. The antioxidant used typically includes 2000 ppm Cyanox-2246, 2000 ppm Irgafos-168 or 1000 ppm ZnO, or equivalents thereof. Preferably, the melt flow rate is from about 0.15 to about 250 g/10 min. More preferably, the melt flow rate is from about 0.2 to about 200 g/10 min. This melt flow rate is measured on the reactor-produced material without subsequent visbreaking.

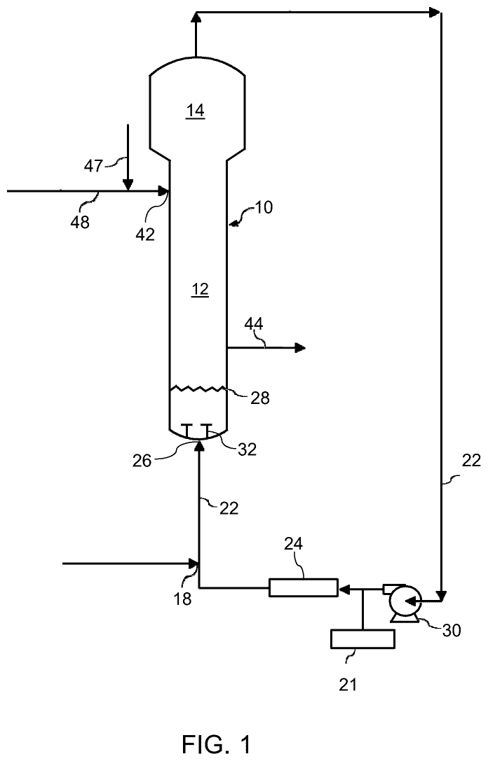

Referring to FIG. 1, for exemplary purposes only, one embodiment of a gas phase polymerization process in a fluidized bed reactor is illustrated. As shown in FIG. 1, the system includes a gas phase reactor 10 that includes a reaction zone 12 and a velocity reduction zone 14. In one exemplary embodiment, the height to diameter ratio of the reaction zone can vary in the range of from about 2:1 to about 7:1.

The reaction zone 12 includes a bed of growing and grown polymer particles, polymerizable monomer(s) and other gaseous components (including inert gases and optionally hydrogen) in the form of fluidizing medium that flows through the reaction zone. The fluidizing medium (typically in gaseous status in most parts of the reactor) is sufficient to produce a fluidized bed. For example, the superficial gas velocity, can be greater than 1.5 times, such as greater than 2.5 times, such as greater than 4 times of the minimum fluidization velocity.

Make-up fluidizing medium (such as fresh polyolefin monomer(s) to make up those consumed during the polymerization) is generally fed to the process at point 18 and combined with a recycle line 22, or other locations in the cycle loop such as upstream of the compressor 30. The composition of the recycle stream is typically measured by a gas analyzer 21. The superficial gas velocity of the fluidizing medium in the reactor 10 can be adjusted by adjusting the flow rate of the fluidizing medium passing the compressor 30. The gas analyzer 21, as shown in FIG. 1, can be positioned to test the recycled gas at a point between a compressor 30 and a heat exchanger 24.

The fluidizing medium contained in the recycle stream 22 is fed to the reactor 10 towards the bottom at a point 26 below the bed. The reactor 10 can include a gas distribution plate 28 to aid in fluidizing the bed uniformly and to support the solid particles contained in the fluidized bed. The fluidizing medium passing upwardly through and out of the bed removes the heat of reaction generated by the exothermic polymerization reaction.

As shown in FIG. 1, the fluidizing medium flows through the reactor 10 and into the velocity reduction zone 14. Within the velocity reduction zone 14, most particles drop back to the dense fluidized bed in the reaction zone 12 by gravity, while a small number of fine particles are carried out of the reactor by the fluidizing medium into the cycle loop.

The recycled fluidizing medium is compressed in compressor 30 and passed through a heat exchanger 24. The heat exchanger 24 is for removing the polymerization-reaction heat absorbed by the fluidizing medium when passing the reactor, before the fluidizing medium is returned to the reactor 10. In one aspect, the reactor 10 can include a fluid flow deflector 32 installed at the inlet to the reactor to help better distribute the fluidizing medium in the space below the distributor plate 28, to prevent contained polymer particles from settling out and agglomerating into a solid mass, and to maintain and entrain or to re-entrain any particles and optionally condensed liquid which may settle out or become disentrained. The distributor plate 28 enables the fluidizing medium to enter the fluidized bed in the reaction zone 12 with a uniform velocity and uniform amount of carried fines particles and optionally uniform amount of condensed liquid, in the entire cross-sectional area of the reactor.

Granular polyolefin polymer resin produced by the reaction is discharged from the reactor 10 through the line 44.

In one embodiment, the polymerization catalyst enters the reactor 10 through a nozzle 42 through line 48.

The catalyst stream 48 includes the catalyst particles, optionally a suspending liquid, such as mineral oil or a liquid alkane, and a carrier fluid. The catalyst particles (for example, in the form of slurry by suspending in mineral oil) and the carrier fluid can be injected into the reactor 10 through the nozzle 42. Preferably, on a volume basis, the catalyst stream 48 primarily contains the carrier fluid. For example, the carrier fluid preferably accounts for greater than 50%, such as greater than 60%, such as greater than 70% of the volume of the catalyst stream 48.

The carrier fluid in the catalyst stream 48 can comprise a monomer, a comonomer, an inert hydrocarbon, an inert gas, or mixtures thereof. In one embodiment, for instance, the carrier fluid is a liquid monomer, such as liquid propylene. When liquid propylene is used as the carrier fluid, the flow rate of the catalyst stream 48 is generally greater than about 15 kg/h, such as greater than about 25 kg/h, such as greater than about 55 kg/h. When liquid propylene is used as the carrier fluid, the flow rate of the catalyst stream 48 is generally less than about 250 kg/h, such as less than about 200 kg/h.

Alternatively, the carrier fluid can be an inert gas, such as nitrogen gas. When nitrogen gas is the carrier fluid, the flow rate of the catalyst stream 48 can generally be greater than about 3 kg/h, such as greater than about 5 kg/h, such as greater than about 9 kg/h, and generally less than about 55 kg/h, such as less than about 45 kg/h, such as less than about 30 kg/h.

In addition to the catalyst stream 48, as shown in FIG. 1, the system may further include a support gas stream 47, separate from the catalyst stream 48 until released into the reactor 10. In one embodiment, for instance, the support gas stream 47 is fed into the gas phase reactor 10 through the nozzle 42 in a manner such that the support gas is released at the tip of tube very close to the tip of the catalyst injection tube. Typically, the support gas flows in the support tube which is coaxially arranged with the catalyst injection tube.

When present, the support gas stream generally comprises a monomer, a comonomer, an inert hydrocarbon, an inert gas, or mixtures thereof. In one embodiment, for instance, the support gas can comprise a monomer gas, such as an olefin gas. In one particular embodiment, for instance, the support gas can be vaporized propylene. Preferably, the flow rate of the support gas is greater than about 40 kg/h, such as greater than about 50 kg/h, such as greater than about 60 kg/h. The flow rate of the support gas is preferably less than about 600 kg/h, such as less than about 550 kg/h, such as less than about 500 kg/h.

In an embodiment, the catalyst system is a Ziegler-Natta catalyst composition. Ziegler-Natta catalyst compositions typically include a procatalyst containing a transition metal halide (i.e., titanium, chromium, vanadium), a cocatalyst such as an organoaluminum compound, and optionally an external electron donor.

All different types of Ziegler-Natta catalysts may be used in the process of the present disclosure. A Ziegler-Natta catalyst includes a solid catalyst component. The solid catalyst component can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable catalyst components include halides, oxyhalides, and alkoxides of magnesium, manganese, titanium, vanadium, chromium, molybdenum, zirconium, hafnium, and combinations thereof.

In one embodiment, the preparation of the catalyst component involves halogenation of mixed magnesium and titanium alkoxides.

In various embodiments, the catalyst component is a magnesium moiety compound (MagMo), a mixed magnesium titanium compound (MagTi), or a benzoate-containing magnesium chloride compound (BenMag). In one embodiment, the catalyst precursor is a magnesium moiety (“MagMo”) precursor. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In another embodiment, the catalyst component is a mixed magnesium/titanium compound (“MagTi”). The “MagTi precursor” has the formula Mg_{d}Ti(OR^{e})fX_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having especially desirable morphology and surface area. Moreover, the resulting precursors are in general particularly uniform in particle size.

In another embodiment, the catalyst precursor is a benzoate-containing magnesium chloride material (“BenMag”). As used herein, a “benzoate-containing magnesium chloride” (“BenMag”) can be a catalyst (i.e., a halogenated catalyst component) containing a benzoate internal electron donor. The BenMag material may also include a titanium moiety, such as a titanium halide. The benzoate internal donor is labile and can be replaced by other electron donors during catalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. In an embodiment, the BenMag catalyst component may be a product of halogenation of any catalyst component (i.e., a MagMo precursor or a MagTi precursor) in the presence of a benzoate compound.

In another embodiment, the solid catalyst component can be formed from a magnesium moiety, a titanium moiety, an epoxy compound, an organosilicon compound, and an internal electron donor. In one embodiment, an organic phosphorus compound can also be incorporated into the solid catalyst component. For example, in one embodiment, a halide-containing magnesium compound can be dissolved in a mixture that includes an epoxy compound, an organic phosphorus compound, and a hydrocarbon solvent. The resulting solution can be treated with a titanium compound in the presence of an organosilicon compound and optionally with an internal electron donor to form a solid precipitate. The solid precipitate can then be treated with further amounts of a titanium compound. The titanium compound used to form the catalyst can have the following chemical formula:

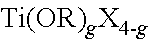

wherein each R is independently a C₁-C₄ alkyl; X is Br, Cl, or I; and g is 0, 1, 2, 3, or 4.

In some embodiments, the organosilicon is a monomeric or polymeric compound. The organosilicon compound may contain —Si—O—Si— groups inside of one molecule or between others. Other illustrative examples of an organosilicon compound include polydialkylsiloxane and/or tetraalkoxysilane. Such compounds may be used individually or as a combination thereof. The organosilicon compound may be used in combination with aluminum alkoxides and an internal electron donor.

The aluminum alkoxide referred to above may be of formula Al(OR′)₃ where each R′ is individually a hydrocarbon with up to 20 carbon atoms. This may include where each R′ is individually methyl, ethyl, n-propyl, iso-propyl, n-butyl, sec-butyl, tert-butyl, n-pentyl, iso-pentyl, neo-pentyl, etc.

Examples of the halide-containing magnesium compounds include magnesium chloride, magnesium bromide, magnesium iodide, and magnesium fluoride. In one embodiment, the halide-containing magnesium compound is magnesium chloride.

Illustrative of the epoxy compounds include, but are not limited to, glycidyl-containing compounds of the Formula:

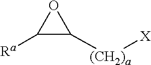

wherein “a” is from 1, 2, 3, 4, or 5, X is F, Cl, Br, I, or methyl, and R^{a} is H, alkyl, aryl, or cyclyl. In one embodiment, the alkylepoxide is epichlorohydrin. In some embodiments, the epoxy compound is a haloalkylepoxide or a nonhaloalkylepoxide.

According to some embodiments, the epoxy compound is selected from the group consisting of ethylene oxide; propylene oxide; 1,2-epoxybutane; 2,3-epoxybutane; 1,2-epoxyhexane; 1,2-epoxyoctane; 1,2-epoxydecane; 1,2-epoxydodecane; 1,2-epoxytetradecane; 1,2-epoxyhexadecane; 1,2-epoxyoctadecane; 7,8-epoxy-2-methyloctadecane; 2-vinyl oxirane; 2-methyl-2-vinyl oxirane; 1,2-epoxy-5-hexene; 1,2-epoxy-7-octene; 1-phenyl-2,3-epoxypropane; 1-(1-naphthyl)-2,3-epoxypropane; 1-cyclohexyl-3,4-epoxybutane; 1,3-butadiene dioxide; 1,2,7,8-diepoxyoctane; cyclopentene oxide; cyclooctene oxide; α-pinene oxide; 2,3-epoxynorbornane; limonene oxide; cyclodecane epoxide; 2,3,5,6-diepoxynorbornane; styrene oxide; 3-methylstyrene oxide; 1,2-epoxybutylbenzene; 1,2-epoxyoctylbenzene; stilbene oxide; 3-vinylstyrene oxide; 1-(1-methyl-1,2-epoxyethyl)-3-(1-methylvinyl benzene); 1,4-bis(1,2-epoxypropyl)benzene; 1,3-bis(1,2-epoxy-1-methylethyl)benzene; 1,4-bis(1,2-epoxy-1-methylethyl)benzene; epifluorohydrin; epichlorohydrin; epibromohydrin; hexafluoropropylene oxide; 1,2-epoxy-4-fluorobutane; 1-(2,3-epoxypropyl)-4-fluorobenzene; 1-(3,4-epoxybutyl)-2-fluorobenzene; 1-(2,3-epoxypropyl)-4-chlorobenzene; 1-(3,4-epoxybutyl)-3-chlorobenzene; 4-fluoro-1,2-cyclohexene oxide; 6-chloro-2,3-epoxybicyclo[2.2.1]heptane; 4-fluorostyrene oxide; 1-(1,2-epoxypropyl)-3-trifluorobenzene; 3-acetyl-1,2-epoxypropane; 4-benzoyl-1,2-epoxybutane; 4-(4-benzoyl)phenyl-1,2-epoxybutane; 4,4′-bis(3,4-epoxybutyl)benzophenone; 3,4-epoxy-1-cyclohexanone; 2,3-epoxy-5-oxobicyclo[2.2.1]heptane; 3-acetylstyrene oxide; 4-(1,2-epoxypropyl)benzophenone; glycidyl methyl ether; butyl glycidyl ether; 2-ethylhexyl glycidyl ether; allyl glycidyl ether; ethyl 3,4-epoxybutyl ether; glycidyl phenyl ether; glycidyl 4-tert-butylphenyl ether; glycidyl 4-chlorophenyl ether; glycidyl 4-methoxyphenyl ether; glycidyl 2-phenylphenyl ether; glycidyl 1-naphthyl ether; glycidyl 2-phenylphenyl ether; glycidyl 1-naphthyl ether; glycidyl 4-indolyl ether; glycidyl N-methyl-α-quinolon-4-yl ether; ethyleneglycol diglycidyl ether; 1,4-butanediol diglycidyl ether; 1,2-diglycidyloxybenzene; 2,2-bis(4-glycidyloxyphenyl)propane; tris(4-glycidyloxyphenyl)methane; poly(oxypropylene)triol triglycidyl ether; a glycidic ether of phenol novolac; 1,2-epoxy-4-methoxycyclohexane; 2,3-epoxy-5,6-dimethoxybicyclo[2.2.1]heptane; 4-methoxystyrene oxide; 1-(1,2-epoxybutyl)-2-phenoxybenzene; glycidyl formate; glycidyl acetate; 2,3-epoxybutyl acetate; glycidyl butyrate; glycidyl benzoate; diglycidyl terephthalate; poly(glycidyl acrylate); poly(glycidyl methacrylate); a copolymer of glycidyl acrylate with another monomer; a copolymer of glycidyl methacrylate with another monomer; 1,2-epoxy-4-methoxycarbonylcyclohexane; 2,3-epoxy-5-butoxycarbonylbicyclo[2.2.1]heptane; ethyl 4-(1,2-epoxyethyl)benzoate; methyl 3-(1,2-epoxybutyl)benzoate; methyl 3-(1,2-epoxybutyl)-5-pheylbenzoate; N,N-glycidyl-methylacetamide; N,N-ethylglycidylpropionamide; N,N-glycidylmethylbenzamide; N-(4,5-epoxypentyl)-N-methyl-benzamide; N,N-diglycylaniline; bis(4-diglycidylaminophenyl)methane; poly(N,N-glycidylmethylacrylamide); 1,2-epoxy-3-(diphenylcarbamoyl)cyclohexane; 2,3-epoxy-6-(dimethylcarbamoyl)bicycle[2.2.1]heptane; 2-(dimethylcarbamoyl)styrene oxide; 4-(1,2-epoxybutyl)-4′-(dimethylcarbamoyl)biphenyl; 4-cyano-1,2-epoxybutane; 1-(3-cyanophenyl)-2,3-epoxybutane; 2-cyanostyrene oxide; and 6-cyano-1-(1,2-epoxy-2-phenylethyl)naphthalene.

As an example of the organic phosphorus compound, phosphate acid esters such as trialkyl phosphate acid ester may be used. Such compounds may be represented by the formula:

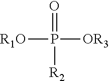

wherein R₁, R₂, and R₃ are each independently selected from the group consisting of methyl, ethyl, and linear or branched (C₃-C₁₀) alkyl groups. In one embodiment, the trialkyl phosphate acid ester is tributyl phosphate acid ester.

In still another embodiment, a substantially spherical MgCl₂-nEtOH adduct may be formed by a spray crystallization process. In the process, a MgCl₂-nROH melt, where n is 1-6, is sprayed inside a vessel while conducting inert gas at a temperature of 20-80° C. into the upper part of the vessel. The melt droplets are transferred to a crystallization area into which inert gas is introduced at a temperature of −50 to 20° C. crystallizing the melt droplets into nonagglomerated, solid particles of spherical shape. The spherical MgCl₂ particles are then classified into the desired size. Particles of undesired size can be recycled. In preferred embodiments for catalyst synthesis the spherical MgCl₂ precursor has an average particle size (Malvern d₅₀) of between about 8-150 microns, preferably between 10-100 microns, and most preferably between 10-30 microns.

The catalyst component may be converted to a solid catalyst by way of halogenation. Halogenation includes contacting the catalyst component with a halogenating agent in the presence of the internal electron donor. Halogenation converts the magnesium moiety present in the catalyst component into a magnesium halide support upon which the titanium moiety (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion. Thus, provision of the internal electron donor yields a catalyst composition with enhanced stereoselectivity.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

The reaction mixture can be heated during halogenation. The catalyst component and halogenating agent are contacted initially at a temperature of less than about 10° C., such as less than about 0° C., such as less than about −10° C., such as less than about −20° C., such as less than about −30° C. The initial temperature is generally greater than about −50° C., such as greater than about −40° C. The mixture is then heated at a rate of 0.1 to 10.0° C./minute, or at a rate of 1.0 to 5.0° C./minute. The internal electron donor may be added later, after an initial contact period between the halogenating agent and catalyst component. Temperatures for the halogenation are from 20° C. to 150° C. (or any value or subrange therebetween), or from 0° C. to 120° C. Halogenation may be continued in the substantial absence of the internal electron donor for a period from 5 to 60 minutes, or from 10 to 50 minutes.

The manner in which the catalyst component, the halogenating agent and the internal electron donor are contacted may be varied. In an embodiment, the catalyst component is first contacted with a mixture containing the halogenating agent and a chlorinated aromatic compound. The resulting mixture is stirred and may be heated if desired. Next, the internal electron donor is added to the same reaction mixture without isolating or recovering of the precursor. The foregoing process may be conducted in a single reactor with addition of the various ingredients controlled by automated process controls.

In one embodiment, the catalyst component is contacted with the internal electron donor before reacting with the halogenating agent.

Contact times of the catalyst component with the internal electron donor are at least 10 minutes, or at least 15 minutes, or at least 20 minutes, or at least 1 hour at a temperature from at least −30° C., or at least −20° C., or at least 10° C. up to a temperature of 150° C., or up to 120° C., or up to 115° C., or up to 110° C.

In one embodiment, the catalyst component, the internal electron donor, and the halogenating agent are added simultaneously or substantially simultaneously.

The halogenation procedure may be repeated one, two, three, or more times as desired. In an embodiment, the resulting solid material is recovered from the reaction mixture and contacted one or more times in the absence (or in the presence) of the same (or different) internal electron donor components with a mixture of the halogenating agent in the chlorinated aromatic compound for at least about 10 minutes, or at least about 15 minutes, or at least about 20 minutes, and up to about 10 hours, or up to about 45 minutes, or up to about 30 minutes, at a temperature from at least about −20° C., or at least about 0° C., or at least about 10° C., to a temperature up to about 150° C., or up to about 120° C., or up to about 115° C.

After the foregoing halogenation procedure, the resulting solid catalyst composition is separated from the reaction medium employed in the final process, by filtering for example, to produce a moist filter cake. The moist filter cake may then be rinsed or washed with a liquid diluent to remove unreacted TiCl₄ and may be dried to remove residual liquid, if desired. Typically the resultant solid catalyst composition is washed one or more times with a “wash liquid,” which is a liquid hydrocarbon such as an aliphatic hydrocarbon such as isopentane, isooctane, isohexane, hexane, pentane, or octane. The solid catalyst composition then can be separated and dried or slurried in a hydrocarbon, especially a relatively heavy hydrocarbon such as mineral oil for further storage or use.

In one embodiment, the resulting solid catalyst composition has a titanium content of from about 1.0 percent by weight to about 6.0 percent by weight, based on the total solids weight, or from about 1.5 percent by weight to about 4.5 percent by weight, or from about 2.0 percent by weight to about 3.5 percent by weight. The weight ratio of titanium to magnesium in the solid catalyst composition is suitably between about 1:3 and about 1:160, or between about 1:4 and about 1:50, or between about 1:6 and 1:30. In an embodiment, the internal electron donor may be present in the catalyst composition in a molar ratio of internal electron donor to magnesium of from about 0.005:1 to about 1:1, or from about 0.01:1 to about 0.4:1. Weight percent is based on the total weight of the catalyst composition.

The catalyst composition may be further treated by one or more of the following procedures prior to or after isolation of the solid catalyst composition. The solid catalyst composition may be contacted (halogenated) with a further quantity of titanium halide compound, if desired; it may be exchanged under metathesis conditions with an acid chloride, such as phthaloyl dichloride or benzoyl chloride; and it may be rinsed or washed, heat treated; or aged. The foregoing additional procedures may be combined in any order or employed separately, or not at all.

As described above, the catalyst composition can include a combination of a magnesium moiety, a titanium moiety and the internal electron donor. The catalyst composition is produced by way of the foregoing halogenation procedure which converts the catalyst component and the internal electron donor into the combination of the magnesium and titanium moieties, into which the internal electron donor is incorporated. The catalyst component from which the catalyst composition is formed can be any of the above described catalyst precursors, including the magnesium moiety precursor, the mixed magnesium/titanium precursor, the benzoate-containing magnesium chloride precursor, the magnesium, titanium, epoxy, and phosphorus precursor, or the spherical precursor.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

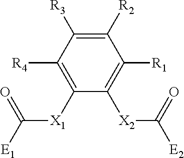

wherein R₁, R₂, R₃ and R₄ are each a hydrocarbyl group having from 1 to 20 carbon atoms, the hydrocarbyl group having a branched or linear structure or comprising a cycloalkyl group having from 7 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X₁ and X₂ are each O, S, an alkyl group, or NR₅ and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In one aspect, the substituted phenylene diester has the following structure (I):

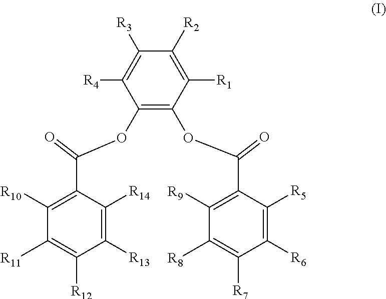

In an embodiment, structure (I) includes R₁ and R₃ that is an isopropyl group. Each of R₂, R₄ and R₅-R₁₄ is hydrogen.

In an embodiment, structure (I) includes each of R₁, R₅, and R₁₀ as a methyl group and R₃ is a t-butyl group. Each of R₂, R₄, R₆-R₉ and R₁₁-R₁₄ is hydrogen.

In an embodiment, structure (I) includes each of R₁, R₇, and R₁₂ as a methyl group and R₃ is a t-butyl group. Each of R₂, R₄, R₅, R₆, R₈, R₉, R₁₀, R₁₁, R₁₃, and R₁₄ is hydrogen.

In an embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In an embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In an embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and R₁₃ is hydrogen.

In an embodiment, the substituted phenylene aromatic diester has a structure selected from the group consisting of structures (II)-(V), including alternatives for each of R₁ to R₁₄, that are described in detail in U.S. Pat. No. 8,536,372, which is incorporated herein by reference.

In an embodiment, structure (I) includes R₁ that is a methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a fluorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a chlorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a bromine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an iodine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₆, R₇, R₁₁, and R₁₂ is a chlorine atom. Each of R₂, R₄, R₅, R₈, R₉, R₁₀, R₁₃, and R₁₄ is hydrogen.

In an embodiment, structure (I) includes R₁ that is a methyl group and R₃ is a t-butyl group. Each of R₆, R₈, R₁₁, and R₁₃ is a chlorine atom. Each of R₂, R₄, R₅, R₇, R₉, R₁₀, R₁₂, and R₁₄ is hydrogen.

In an embodiment, structure (I) includes R₁ that is a methyl group and R₃ is a t-butyl group. Each of R₂, R₄ and R₅-R₁₄ is a fluorine atom.

In an embodiment, structure (I) includes R₁ that is a methyl group and R₃ is a t-butyl group. Each of R₇ and R₁₂ is a trifluoromethyl group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an ethoxycarbonyl group. Each of R₂, R₄, R₅, R₆, R₈, R₉, R₁₀, R₁₁, R₁₃, and R₁₄ is hydrogen.

In an embodiment, R₁ is methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a diethylamino group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a 2,4,4-trimethylpentan-2-yl group. Each of R₂, R₄ and R₅-R₁₄ is hydrogen.

In an embodiment, structure (I) includes R₁ and R₃, each of which is a sec-butyl group. Each of R₂, R₄ and R₅-R₁₄ is hydrogen.

In an embodiment, structure (I) includes R₁ and R₄ that are each a methyl group. Each of R₂, R₃, R₅-R₉ and R₁₀-R₁₄ is hydrogen.

In an embodiment, structure (I) includes R₁ that is a methyl group. R₄ is an i-propyl group. Each of R₂, R₃, R₅-R₉ and R₁₀-R₁₄ is hydrogen.

In an embodiment, structure (I) includes R₁, R₃, and R₄, each of which is an i-propyl group. Each of R₂, R₅-R₉ and R₁₀-R₁₄ is hydrogen.

In another aspect, the internal electron donor can be a phthalate compound. For example, the phthalate compound can be dimethyl phthalate, diethyl phthalate, dipropyl phthalate, diisopropyl phthalate, dibutyl phthalate, diisobutyl phthalate, diamyl phthalate, diisoamyl phthalate, methylbutyl phthalate, ethylbutyl phthalate, or ethylpropyl phthalate.

In addition to the solid catalyst component as described above, the Ziegler-Natta catalyst system of the present disclosure can also include a cocatalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

Suitable catalyst compositions can include the solid catalyst component, a co-catalyst, and an external electron donor that can be a mixed external electron donor (M-EED) of two or more different components. Suitable external electron donors or “external donor” include one or more selectivity control agents (SCA) and/or one or more activity limiting agents (ALA). As used herein, an “external donor” is a component or a composition comprising a mixture of components added independent of procatalyst formation that modifies the catalyst performance. As used herein, an “activity limiting agent” is a composition that decreases catalyst activity as the polymerization temperature in the presence of the catalyst rises above a threshold temperature (e.g., temperature greater than about 95° C.). A “selectivity control agent” is a composition that improves polymer tacticity, wherein improved tacticity is generally understood to mean increased tacticity or reduced xylene solubles or both. It should be understood that the above definitions are not mutually exclusive and that a single compound may be classified, for example, as both an activity limiting agent and a selectivity control agent.

A selectivity control agent in accordance with the present disclosure is generally an organosilicon compound. For example, in one aspect, the selectively control agent can be an alkoxysilane.

In one embodiment, the alkoxysilane can have the following general formula: SiRₘ(OR′)₄₋ₘ (I) where R independently each occurrence is hydrogen or a hydrocarbyl or an amino group optionally substituted with one or more substituents containing one or more Group 14, 15, 16, or 17 heteroatoms, said R containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2. In one embodiment, for instance, the second selectivity control agent may comprise n-propyltriethoxysilane. Other selectively control agents that can be used include propyltriethoxysilane or diisobutyldimethoxysilane.

In one embodiment, the catalyst system may include an activity limiting agent (ALA). An ALA inhibits or otherwise prevents polymerization reactor upset and ensures continuity of the polymerization process. Typically, the activity of Ziegler-Natta catalysts increases as the reactor temperature rises before reaching a very high level. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester. The aliphatic carboxylic acid ester may be a C₄-C₃₀ aliphatic acid ester, may be a mono- or a poly- (two or more) ester, may be straight chain or branched, may be saturated or unsaturated, and any combination thereof. The C₄-C₃₀ aliphatic acid ester may also be substituted with one or more Group 14, 15 or 16 heteroatom containing substituents. Nonlimiting examples of suitable C₄-C₃₀ aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono- or polycarboxylate derivatives of C₂₋₁₀₀ (poly)glycols or C₂₋₁₀₀ (poly)glycol ethers. In a further embodiment, the C₄-C₃₀ aliphatic acid ester may be a laurate, a myristate, a palmitate, a stearate, an oleates, a sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-oleates, glyceryl tri(acetate), glyceryl tri-ester of C₂₋₄₀ aliphatic carboxylic acids, and mixtures thereof. In a further embodiment, the C₄-C₃₀ aliphatic ester is isopropyl myristate, di-n-butyl sebacate and/or pentyl valerate.

In one embodiment, the selectivity control agent and/or activity limiting agent can be added into the reactor separately. In another embodiment, the selectivity control agent and the activity limiting agent can be mixed together in advance and then added into the reactor as a mixture. In addition, the selectivity control agent and/or activity limiting agent can be added into the reactor in different ways. For example, in one embodiment, the selectivity control agent and/or the activity limiting agent can be added directly into the reactor, such as into a fluidized bed reactor. Alternatively, the selectivity control agent and/or activity limiting agent can be added indirectly to the reactor volume by being fed through, for instance, a cycle loop (for example, the Line 22 in FIG. 1). The selectivity control agent and/or activity limiting agent can combine with the reactor cycle gas within the cycle loop prior to being fed into the reactor.

In addition to Ziegler-Natta catalysts, the process of the present disclosure may also use a metallocene catalyst. Metallocene catalysts can include “half sandwich” and “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom.

The Cp ligands are one or more rings or ring system(s), at least a portion of which includes π-bonded systems, such as cycloalkadienyl ligands and heterocyclic analogues. The ring(s) or ring system(s) typically comprise atoms selected from Groups 13 to 16 atoms, and, in some embodiments, the atoms that make up the Cp ligands are selected from carbon, nitrogen, oxygen, silicon, sulfur, phosphorous, germanium, boron, aluminum, and combinations thereof, where carbon makes up at least 50% of the ring members. For example, the Cp ligand(s) may be selected from substituted and unsubstituted cyclopentadienyl ligands and ligands isolobal to cyclopentadienyl. Non-limiting examples of such ligands include cyclopentadienyl, cyclopentaphenanthrenyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄ Ind”), substituted versions thereof (as discussed and described in more detail below), and heterocyclic versions thereof.

The metal atom “M” of the metallocene compound may be selected from Groups 3 through 12 atoms and lanthanide Group atoms; or may be selected from Groups 3 through 10 atoms; or may be selected from Sc, Ti, Zr, Hf, V, Nb, Ta, Mn, Re, Fe, Ru, Os, Co, Rh, Ir, and Ni; or may be selected from Groups 4, 5, and 6 atoms; or may be Ti, Zr, or Hf atoms; or may be Hf; or may be Zr. The oxidation state of the metal atom “M” can range from 0 to +7; or may be +1, +2, +3, +4 or +5; or may be +2, +3 or +4. The groups bound to the metal atom “M” are such that the compounds described below in the structures and structures are electrically neutral, unless otherwise indicated. The Cp ligand(s) forms at least one chemical bond with the metal atom M to form the “metallocene catalyst component.” The Cp ligands are distinct from the leaving groups bound to metal atom M in that they are not highly susceptible to substitution/abstraction reactions.

In one embodiment, the metallocene catalyst may be represented by the following formula:

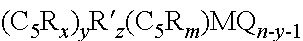

wherein:
M is a metal of Groups IIIB to VIII of the Periodic Table of the Elements;
(C₅Rₓ) and (C₅Rₘ) are the same or different cyclopentadienyl or substituted cyclopentadienyl groups bonded to M;
R is the same or different and is hydrogen or a hydrocarbyl radical such as alkyl, alkenyl, aryl, alkylaryl, or arylalkyl radical containing from 1 to 20 carbon atoms or two carbon atoms are joined together to form a C₄-C₆ ring;
R′ is a C₁-C₄ substituted or unsubstituted alkylene radical, a dialkyl or diaryl germanium or silicon, or an alkyl or aryl phosphine or amine radical bridging two (C₅Rₓ) and (C₅Rₘ) rings;
Q is a hydrocarbyl radical such as aryl, alkyl, alkenyl, alkylaryl, or aryl alkyl radical having from 1-20 carbon atoms, hydrocarboxy radical having from 1-20 carbon atoms or halogen and can be the same or different from each other;
z is 0 or 1;
y is 0, 1 or 2;
z is 0 when y is 0;
n is 0, 1, 2, 3, or 4 depending upon the valence state of M;
and n−y is ≥1.

Illustrative but non-limiting examples of the metallocenes represented by the above formula are dialkyl metallocenes such as bis(cyclopentadienyl)titanium dimethyl, bis(cyclopentadienyl)titanium diphenyl, bis(cyclopentadienyl)zirconium dimethyl, bis(cyclopentadienyl)zirconium diphenyl, bis(cyclopentadienyl)hafnium dimethyl and diphenyl, bis(cyclopentadienyl)titanium di-neopentyl, bis(cyclopentadienyl)zirconium di-neopentyl, bis(cyclopentadienyl)titanium dibenzyl, bis(cyclopentadienyl)zirconium dibenzyl, bis(cyclopentadienyl)vanadium dimethyl; the mono alkyl metallocenes such as bis(cyclopentadienyl)titanium methyl chloride, bis(cyclopentadienyl)titanium ethyl chloride, bis(cyclopentadienyl)titanium phenyl chloride, bis(cyclopentadienyl)zirconium methyl chloride, bis(cyclopentadienyl)zirconium ethyl chloride, bis(cyclopentadienyl)zirconium phenyl chloride, bis(cyclopentadienyl)titanium methyl bromide; the trialkyl metallocenes such as cyclopentadienyl titanium trimethyl, cyclopentadienyl zirconium triphenyl, and cyclopentadienyl zirconium trineopentyl, cyclopentadienyl zirconium trimethyl, cyclopentadienyl hafnium triphenyl, cyclopentadienyl hafnium trineopentyl, and cyclopentadienyl hafnium trimethyl; monocyclopentadienyls titanocenes such as, pentamethylcyclopentadienyl titanium trichloride, pentaethylcyclopentadienyl titanium trichloride; bis(pentamethylcyclopentadienyl) titanium diphenyl, the carbene represented by the formula bis(cyclopentadienyl)titanium=CH₂ and derivatives of this reagent; substituted bis(cyclopentadienyl)titanium (IV) compounds such as: bis(indenyl)titanium diphenyl or dichloride, bis(methylcyclopentadienyl)titanium diphenyl or dihalides; dialkyl, trialkyl, tetra-alkyl and penta-alkyl cyclopentadienyl titanium compounds such as bis(1,2-dimethylcyclopentadienyl)titanium diphenyl or dichloride, bis(1,2-diethylcyclopentadienyl)titanium diphenyl or dichloride; silicon, phosphine, amine or carbon bridged cyclopentadiene complexes, such as dimethyl silyldicyclopentadienyl titanium diphenyl or dichloride, methyl phosphine dicyclopentadienyl titanium diphenyl or dichloride, methylenedicyclopentadienyl titanium diphenyl or dichloride and other dihalide complexes, and the like; as well as bridged metallocene compounds such as isopropyl(cyclopentadienyl)(fluorenyl)zirconium dichloride, isopropyl(cyclopentadienyl) (octahydrofluorenyl)zirconium dichloride diphenylmethylene(cyclopentadienyl)(fluorenyl) zirconium dichloride, diisopropylmethylene (cyclopentadienyl)(fluorenyl)zirconium dichloride, diisobutylmethylene(cyclopentadienyl)(fluorenyl) zirconium dichloride, ditertbutylmethylene (cyclopentadienyl)(fluorenyl)zirconium dichloride, cyclohexylidene(cyclopentadienyl)(fluorenyl) zirconium dichloride, diisopropylmethylene (2,5-dimethylcyclopentadienyl)(fluorenyl)zirconium dichloride, isopropyl(cyclopentadienyl)(fluorenyl) hafnium dichloride, diphenylmethylene (cyclopentadienyl) (fluorenyl)hafnium dichloride, diisopropylmethylene(cyclopentadienyl) (fluorenyl)hafnium dichloride, diisobutylmethylene(cyclopentadienyl) (fluorenyl)hafnium dichloride, ditertbutylmethylene(cyclopentadienyl) (fluorenyl)hafnium dichloride, cyclohexylidene(cyclopentadienyl)(fluorenyl)hafnium dichloride, diisopropylmethylene(2,5-dimethylcyclopentadienyl) (fluorenyl)hafnium dichloride, isopropyl(cyclopentadienyl)(fluorenyl)titanium dichloride, diphenylmethylene(cyclopentadienyl) (fluorenyl)titanium dichloride, diisopropylmethylene(cyclopentadienyl) (fluorenyl)titanium dichloride, diisobutylmethylene(cyclopentadienyl) (fluorenyl)titanium dichloride, ditertbutylmethylene(cyclopentadienyl) (fluorenyl)titanium dichloride, cyclohexylidene(cyclopentadienyl) (fluorenyl)titanium dichloride, diisopropylmethylene(2,5 dimethylcyclopentadienyl fluorenyl)titanium dichloride, racemic-ethylene bis(1-indenyl) zirconium (IV) dichloride, racemic-ethylene bis(4,5,6,7-tetrahydro-1-indenyl) zirconium (IV) dichloride, racemic-dimethylsilyl bis(1-indenyl) zirconium (IV) dichloride, racemic-dimethylsilyl bis(4,5,6,7-tetrahydro-1-indenyl) zirconium (IV) dichloride, racemic-1,1,2,2-tetramethylsilanylene bis(1-indenyl) zirconium (IV) dichloride, racemic-1,1,2,2-tetramethylsilanylene bis(4,5,6,7-tetrahydro-1-indenyl) zirconium (IV), dichloride, ethylidene (1-indenyl tetramethylcyclopentadienyl) zirconium (IV) dichloride, racemic-dimethylsilyl bis(2-methyl-4-t-butyl-1-cyclopentadienyl) zirconium (IV) dichloride, racemic-ethylene bis(1-indenyl) hafnium (IV) dichloride, racemic-ethylene bis(4,5,6,7-tetrahydro-1-indenyl) hafnium (IV) dichloride, racemic-dimethylsilyl bis(1-indenyl) hafnium (IV) dichloride, racemic-dimethylsilyl bis(4,5,6,7-tetrahydro-1-indenyl) hafnium (IV) dichloride, racemic-1,1,2,2-tetramethylsilanylene bis(1-indenyl) hafnium (IV) dichloride, racemic-1,1,2,2-tetramethylsilanylene bis(4,5,6,7-tetrahydro-1-indenyl) hafnium (IV), dichloride, ethylidene (1-indenyl-2,3,4,5-tetramethyl-1-cyclopentadienyl) hafnium (IV) dichloride, racemic-ethylene bis(1-indenyl) titanium (IV) dichloride, racemic-ethylene bis(4,5,6,7-tetrahydro-1-indenyl) titanium (IV) dichloride, racemic-dimethylsilyl bis(1-indenyl) titanium (IV) dichloride, racemic-dimethylsilyl bis(4,5,6,7-tetrahydro-1-indenyl) titanium (IV) dichloride, racemic-1,1,2,2-tetramethylsilanylene bis(1-indenyl) titanium (IV) dichloride racemic-1,1,2,2-tetramethylsilanylene bis(4,5,6,7-tetrahydro-1-indenyl) titanium (IV) dichloride, and ethylidene (1-indenyl-2,3,4,5-tetramethyl-1-cyclopentadienyl) titanium IV) dichloride.

An activator may also be used with the metallocene catalyst. The activator, for instance, may be an aluminoxane. Activators that may be used include those that have the following general formula:

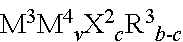

wherein M³ is a metal of Groups IA, IIA and IIIA of the periodic table; M⁴ is a metal of Group IA of the Periodic table; v is a number from 0 to 1; each X² is any halogen; c is a number from 0 to 3; each R³ is a monovalent hydrocarbon radical or hydrogen; b is a number from 1 to 4; and wherein b−c is at least 1.

Compounds having only one Group IA, IIA or IIIA metal which are suitable for the practice of the invention include compounds having the formula:

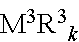

wherein:
M³ is a Group IA, IIA or IIIA metal, such as lithium, sodium, beryllium, barium, boron, aluminum, zinc, cadmium, and gallium;
k equals 1, 2 or 3 depending upon the valency of M³ which valency in turn normally depends upon the particular group (i.e., IA, IIA or IIIA) to which M³ belongs; and
each R³ may be any monovalent hydrocarbon radical. Examples of suitable R³ groups include any of the R³ groups aforementioned in connection with formula (V).

The present disclosure may be better understood with reference to the following examples of commercial-scale propylene-ethylene random copolymer production.

### Examples

### Test Methods:

Melt Flow Rate was measured according to ASTM D1238-01 under the conditions of 2.16 kg weight and 230° C.

Composition of the fluidizing medium was measured by on-line GC, which was frequently calibrated with check gas to ensure the sum of all the components is between 99% and 101%.

Various polypropylene random copolymers were produced in commercial scale fluidized bed reactors. The operating conditions for each run are listed below in Table 1. Additionally, the stability of the reactor operation was evaluated for each run.

Various catalyst systems were used in order to produce the polypropylene random copolymers. For Run Nos. 1, 2 and 3, the catalyst used was made according to U.S. Pat. No. 5,604,172, which is incorporated herein by reference. The external electron donor used was made according to U.S. Patent Application No. 2011/0152067, Example 11. For Run Nos. 4 and 5, the catalyst was made according to U.S. Pat. No. 9,593,182, Example 10. The external donor used was made according to U.S. Patent Application No. 2011/0152067, Example B1. For Run Nos. 6 and 7, the catalyst used was made according to U.S. Patent Application No. 2010/0173769, Example 4. The external electron donor used was made according to U.S. Patent Application No. 2011/0152067, Example H1.

In Run Nos. 3, 5 and 7, the partial pressure of polypropylene was maintained in accordance with the present disclosure according to the following relationship:

$${0.9}^{*} ( 4.31 - 0.301 {E}_{t} - 0.015 T ) < PPpropylene < {1.1}^{*} ( 4.31 - 0.301 {E}_{t} - 0.015 T )$$

wherein:
Et is the comonomer content in the copolymer (in wt %);
T is the bed temperature (in ° C.); and
PPpropylene is the partial pressure of propylene (in MPa).
   Run Nos. 1, 2, 4, and 6 are comparative examples. In Run Nos. 1, 2 and 6, the polypropylene random copolymer was produced in which the polypropylene partial pressure was outside of the operating window according to the above relationship. In Comparative Run No. 4, the polypropylene partial pressure was within the limits defined above but with very low condensing level of the fluidizing medium (only at 3% by weight).

| | | | | | | Lower |
|---|---|---|---|---|---|---|
| | | Ethylene | | | | Range of |
| Run | Production | content | MFR | T | C3pp | C3PP |
| No. | Rate (T/H) | (wt %) | (g/10 min) | (° C.) | (MPa) | (C = 0.9) |
| 1 | 42 | 3.7 | 12 | 68 | 2.40-2.60 | 1.96 |
| 2 | 40 | 3.7 | 25 | 65 | 2.42-2.46 | 2.00 |
| 3 | 36.4 | 3.6 | 25 | 62.2 | 2.21 | 2.06 |
| 4 | 31 | 3.7 | 12 | 63.5 | 2.37 | 2.02 |
| 5 | 31.2 | 3.5 | 25 | 62 | 2.21 | 2.09 |
| 6 | 18.3 | 4.8 | 68 | 65.4 | 2.07 | 1.70 |
| 7 | 18.3 | 4.8 | 68 | 65.4 | 1.93 | |

| | High | | | |
|---|---|---|---|---|
| | range of | | | |
| Run | C3PP | Operation | Propane | Condensing |
| No. | (C = 1.1) | Observation | level (%) | (wt %) |
| 1 | 2.39 | Reactor was chunked | 3% | 5-8% |
| | | after several hours of | | |
| | | operation | | |
| 2 | 2.44 | Reactor was running | 3.0% | 7.9% |
| | | for 2 days and ended | | |
| | | with hot spots and | | |
| | | agglomerations formed | | |
| | | in reactor, some | | |
| | | reactor-wall | | |
| | | thermocouples went | | |
| | | hotter, reactor was | | |
| | | shut down for cleaning | | |
| 3 | 2.52 | Very good operation | 12.4% | 12.0% |
| | | and good particle | | |
| | | morphology | | |
| 4 | 2.47 | Agglomerating in | 3.4% | 3.0% |
| | | reactor, reactor had to | | |
| | | shut down for cleaning | | |
| 5 | 2.56 | Very good operation | 11.3% | 7.3% |
| | | and good particle | | |
| | | morphology | | |
| 6 | 2.07 | Particles on #5 mesh | 17.7% | 14.5% |
| | | went up to be >2.0 | | |
| | | wt % | | |
| 7 | | Particles on #5 mesh | | |
| | | disappeared; stable | | |
| | | operation, good | | |
| | | particle morphology | | |

As you can see, Run Nos. 3, 5, and 7 were dramatically better than the remaining runs.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A process for producing a polypropylene-ethylene random copolymer in a reactor comprising:
feeding a gaseous medium into a reactor vessel containing a bed of catalytically active polyolefin particles, the gaseous medium comprising propylene gas, ethylene comonomer, optionally hydrogen, and at least one inert gas;
wherein the propylene gas is maintained in the reactor vessel at a partial pressure according to the following relationship:
$${0.9}^{*} ( 4.31 - 0.301 {E}_{t} - 0.015 T ) < {PP}_{propylene} < {1.1}^{*} ( 4.31 - 0.301 {E}_{t} - 0.015 T )$$
wherein:
Et is the ethylene comonomer content in the copolymer (in wt %);
T is the bed temperature (in ° C.); and
PP_{propylene} is the partial pressure of propylene (in MPa).

2. A process as defined in claim 1, wherein the ethylene content in the copolymer is greater than about 2% by weight and less than about 10% by weight.

3. A process as defined in claim 1, wherein the inert gas comprises propane.

4. A process as defined in claim 3, further comprising the step of recycling the gaseous medium exiting the reactor vessel back to the reactor vessel.

5. A process as defined in claim 4, wherein propane and/or propylene are combined with the recycled gaseous medium for feeding to the reactor vessel.

6. A process as defined in claim 5, wherein the propane is maintained in the reactor vessel at a partial pressure according to the following relationship:
$${PP}_{propane} = {PP}_{total \_ C 3} - {PP}_{propylene}$$
wherein:
PPₚᵣₒₚₐₙₑ is the partial pressure of propane;
PP_{total_C3} is the total partial pressure of C3 hydrocarbons (e.g., propylene and propane); and
PP_{propylene} is the partial pressure of propylene.

7. A process as defined in claim 6, wherein fluidizing gases recycled back to the reactor vessel condense during the process and wherein PPₚᵣₒₚₐₙₑ is adjusted during the process so the amount of condensed gases is from about 5% by weight to about 20% by weight.

8. A process as defined in claim 7, wherein the amount of PPₚᵣₒₚₐₙₑ is adjusted during the process by adding propane to the gaseous medium fed to the reactor vessel.

9. A process as defined in claim 3, wherein the gaseous medium contains propane in an amount from about 6 mol % to about 23 mol %.

10. A process as defined in claim 1, wherein the gaseous medium further comprises nitrogen gas.

11. A process as defined in claim 1, further comprising the step of feeding a catalyst into the reactor vessel.

12. A process as defined in claim 11, wherein the catalyst comprises a Ziegler-Natta catalyst.

13. A process as defined in claim 11, wherein the catalyst comprises a metallocene catalyst.

14. A process as defined in claim 6, wherein the PP_{total_C3} is maintained during the process within a range of from about 1.5 MPa to about 3 MPa.

15. A process as defined in claim 1, wherein the polypropylene random copolymer as produced during the process displays a melt flow rating of from about 0.15 g/10 min to about 400 g/10 min.

16. A process as defined in claim 1, wherein the bed temperature is maintained in a range of from about 55° C. to about 90° C.
